(19) United States
(12) Patent Application Publication
(10) Pub. No.: US 2010/0156782 A1
(43) Pub. Date: Jun. 24, 2010

(54) Hand Control Image For Replication

(75) Inventors: John Thomas Kosinski, II, River Rouge, MI (US); Michael Dean Tschirhart, Ann Arbor, MI (US)

Correspondence Address: DICKINSON WRIGHT PLLC, 38525 WOODWARD AVENUE, SUITE 2000, BLOOMFIELD HILLS, MI, 48304-2970, US

(73) Assignee: VISTEON GLOBAL TECHNOLOGIES, INC., Van Buren Township, MI (US)

(21) Appl. No.: 12/627,215

(22) Filed: Nov. 30, 2009

Related U.S. Application Data
(60) Provisional application No. 61/138,647, filed on Dec. 18, 2008.

(51) Int. Cl. G09G 5/00; G06F 3/041

(52) U.S. Cl. 345/156; 345/173

(57) ABSTRACT

A system and method for a display in the gaze-forward position of a vehicle operator, showing hand position relative to various control inputs or hand positions relative to a control surface. The hand replication system includes a control input device, a display displaying an image of the control input device, an optical input device directed to capturing an actual image of the control input device and providing the actual image output to one of a display or a processor. The method of providing an image of an operators hand relative to a control panel within the line of sight of the vehicle operator includes the steps of providing a display, providing an optical input device, obtaining an actual image of the control panel with the optical input device, and providing the actual image of the control panel to the display.

### CROSS REFERENCE TO RELATED APPLICATION

This application claims priority to U.S. Provisional Application Ser. No. 61/138,647 filed on Dec. 18, 2008, entitled “Hand Control Image For Replication,” the entire disclosure of the application being considered part of the disclosure of this application and hereby incorporated by reference.

### BACKGROUND OF THE INVENTION

1. Field of the Invention

The present invention is directed to a system and method for creating a display in the gaze-forward position of a vehicle operator, showing hand position relative to various control inputs or hand positions relative to a control surface.

2. Discussion

During vehicle operation to the numerous control features in modern vehicles, an operator may feel the need to turn away from the gaze-forward position. As manufacturers add more content and options to vehicles, such as MP3 players, navigation systems and more, manufacturers also strive to minimize distractions during operation of the vehicle and the need for the operator to deviate from their sight line from the gaze-forward position. As used herein, the gaze-forward position generally refers to the line of sight of the operator in the direction of travel or desired direction of travel. For example, the radio and other electronic devices and controls, such as controls on the center console, and center stack of the instrument panel, are generally not substantially within the gaze-forward position. In comparison, the view out of the windshield as well as the speedometer, gauges near the speedometer and the immediate surrounding area of the steering wheel are generally sufficiently within the gaze-forward position.

### SUMMARY OF THE INVENTION

The present invention is directed to a system and method to allow a vehicle operator to easily and accurately control various vehicle electronic devices while maintaining a substantially gaze-forward line-of-sight position.

The invention generally uses an image input device to capture hand positions relative to various controls or relative to a control panel and then outputs that position to a display substantially within the area of the gaze-forward position. This allows the user without substantially removing their line-of-sight from the gaze-forward position to see the proximity of their hand relative to various controls and eases the ability of the user to efficiently and accurately control various devices with minimal distractions.

### BRIEF DESCRIPTION OF THE DRAWINGS

Other advantages of the present invention will be readily appreciated and more fully understood by reference to the following detailed description when considered in connection with the accompanying drawing wherein:

FIG. 1 illustrates a user inputting or controlling devices through a control panel and a display in the gaze-forward position revealing the position of the hand relative to the control panel; and

FIG. 2 is directed to controlling various devices on the center stack of the instrument panel and a display showing the hand position relative to the devices on the center stack in the gaze-forward position.

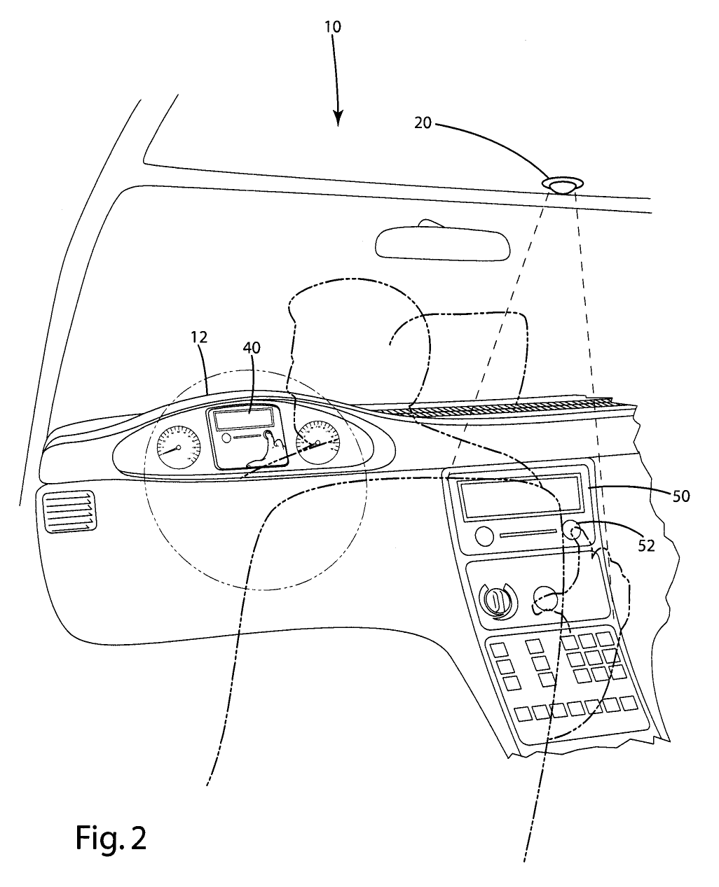

### DETAILED DESCRIPTION OF THE INVENTION

As illustrated in the figures, the present invention generally includes a system 10 having an image input device 20, a processor 30, and a display 40, and various control inputs 50. The system 10 uses the input device 20 to capture the position of the vehicle operator's hand, and processes it with a processor 30 to output it on a display 40 in the gaze-forward position.

To allow a user to substantially maintain a gaze-forward position in the direction of travel or desired direction of travel of the vehicle, the present invention provides a display output 40 substantially within the gaze-forward position showing hand position relative to various controls while the display 40 is illustrated at the upper center to left of center of the instrument panel, it may be positioned anywhere substantially within or near the gaze forward position. For example, the display 40 may be located between the gauges or as part of a heads up display projected on the windshield of the vehicle.

The input device 20 is positioned in the vehicle to see hand movements when they are operating certain controls to various devices in the vehicle. For example, locations for the visual input device 20 may be near the overhead or dome light, in the operator headrest, in the passenger seat headrest, in the center console and the like. Positioning of the input device 20 should allow a substantially clear picture of the operator's hand relative to certain controls and minimize situations where the input device could potentially be blocked from such a view. Some systems 10 may include multiple input devices 20 with the processor 30 determining what viewing angle to display in the display 40. Of course, the system may be configured to allow the user to select the desired view. The input device may be any type of visual device such as a digital camera, video camera, CCD, or any other device capable of capturing an image or motions of the vehicle user's hand.

In some embodiments, the system 10 may be formed without the processor 30 providing a direct link from the input device 20 to the display 40. However, in most instances, it is believed that a processor 30 will be helpful in processing the image to provide a better output to the display 40. The processor 40 may be any device capable of processing the image.

The processor 40 may be used to create a semi-transparent or ghost view of the hand relative to the controls 50. This allows the operator to see various controls, which would be blocked from a clear view by the hand. More specifically, the processor 40 may meld views of the controls of a display without an intervening hand with images of a hand over the controls 50.

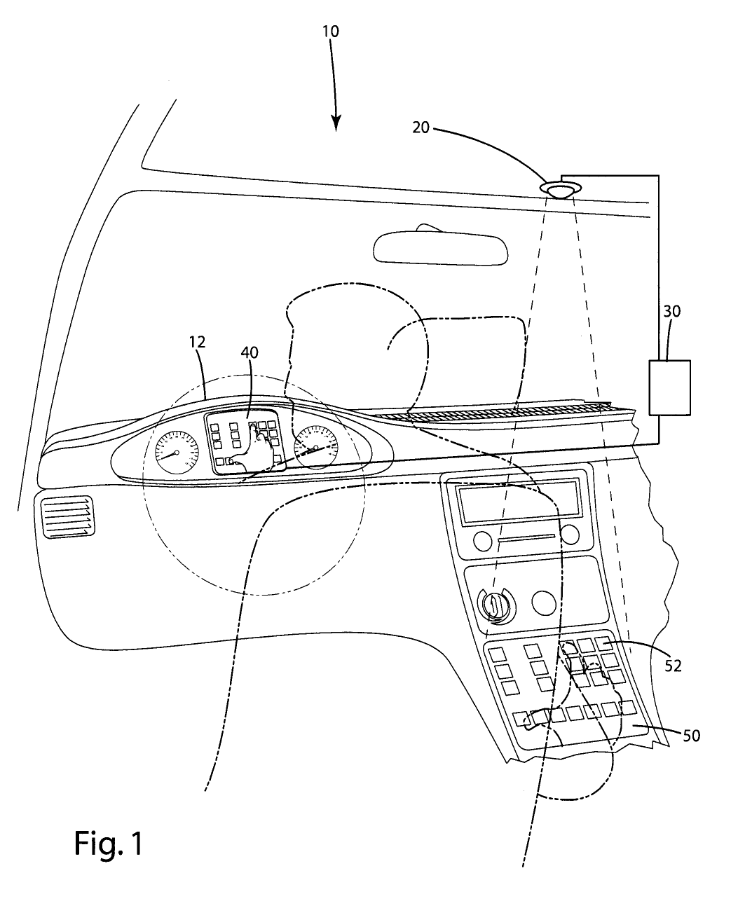

In some embodiments, the system 10 may include a control surface 50 which may be have variable buttons or inputs that depend upon selected menus by the user as well as positioning of the hand relative to the control surface 50. The control surface 50 may be a touch screen surface or may be interactive using the coordination between the input device 20, processor 30, and movement of the hand positions of the user relative to the control surface 50. The control surface 50 may be located on the center counsel as illustrated in FIG. 1 or may be the display of the vehicle entertainment system (not illustrated) located on the center stack. The control surface 50 displayed may be output also to the display 40 and the image from the input device 20 with the hand may be directly laid over an identical image as displayed on the touch screen, without the need to be melded with an image without the hand. As the user controls various controls 52, the image displayed on the control surface 50 is simultaneously displayed in the display 40.

The display 40 may be any type of display such as an LCD screen, E-ink, or otherwise and may be in color or in black and white and would show the hand of the user in the vicinity of the gaze-forward position. The display 40 may also be a heads-up display that is projected on the windshield of a vehicle. The display 40 is generally located in the gaze-forward position such as in the center instrument panel close to the speedometer in most vehicles, or in close proximity to the upper surface of the dashboard 12.

In some embodiments, the control panel 50 may be combined with the input device 20 by using a conventional or higher R-based camera that detects the position of the hand over the control panel 50. A representation of the control panel 50 may be displayed on the display 40 with a ghost image of the driver's hand on the control surface to facilitate control management with greatly reduced glance deviation as well as allow the user to see what is under the hand with relative ease. The processor 30 may take the image of the hand over the control surface and output it in combination with an image of what is displayed on the control surface to the display 40. This will allow a transparent or ghost image of the operator's hand while showing very clearly the underlying displayed control panel.

For hard key control panels and devices 50, a picture of the device may be entered into the system ahead of time and the processor 30 may combine with the image of the device to show a position of the hand relative to the control devices 50. Therefore, as a person's hand moves over the control surface or control panel 50, a ghost image of the user's hand appears in real time in the display 40 representing a fast, intuitive control management with reduced glance deviation from the gaze-forward position.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A hand replication system for vehicles comprising:
a control input device;
a display located remotely from said control input device and displaying an image of said control input device;
an optical input device directed to and optically focused approximately on said control input device and capturing an actual image and providing said actual image output to said processor; and
a processor in electronic communication with said control input device and an optical input device.

2. The hand replication system for vehicles of claim 1 wherein said processor includes a memory module having a stored image of an unobstructed control input device.

3. The hand replication system for vehicles of claim 1 wherein said processor provides a blended image of said stored image from said memory module and said actual image from said optical input device to said display.

4. A vehicle comprising:
an instrument panel including a display in the line of sight of the vehicle operator;
a control input located out of the line of sight of the vehicle operator; and
an optical input device in electronic communication with said display and directed at said control input for displaying said control input on said display.

5. The vehicle of claim 4 further including a processor in electronic communication with said display and said optical input device.

6. The vehicle of claim 5 wherein said processor includes a memory device including an image of the control input without obstructions.

7. The vehicle of claim 4 wherein said optical input device is located in on of a seat headrest, headliner of the vehicle, rearview mirror and a headliner mounted instrument panel.

8. The vehicle of claim 4 wherein said control input is located on the center console of the vehicle.

9. The vehicle of claim 4 wherein said control input is a touch screen interface.

10. A method of providing an image of an operators hand relative to a control panel within the line of sight of the vehicle operator comprising:
providing a display;
providing an optical input device;
obtaining an actual image of the control panel with the optical input device;
providing the actual image of the control panel to the display.

11. The method of claim 10 further including the step of storing an unobstructed image of the control panel before said step of obtaining an actual image of the control panel with the optical input device.

12. The method of claim 11 further including the step of blending said actual image with said unobstructed image and outputting said blended image to the display.

13. The method of claim 10 wherein said control panel is a touch screen and further including the step of providing a mirror image of the display on the touch screen to the display.

14. The method of claim 10 further including the step of providing a processor.

15. The method of claim 14 wherein said control panel is a touch screen and further including the step of providing a mirror image of the touch screen to the processor.

16. The method of claim 14 further including the step of blending the actual image with the mirror image with said processor.

17. The method of claim 16 further including the step of providing said blended image from said processor to said display.

18. The method of claim 10 wherein said step of providing said actual image to said display further includes the step of providing said image to said processor and overlaying and adding an unobstructed image to said actual image to create a blended image.

19. A method of providing an image of an operators hand relative to a control panel within the line of sight of the vehicle operator comprising:
providing a display;
providing an optical input device;
providing a processor;
obtaining an actual image of the control panel with the optical input device;
providing the actual image of the control panel to the processor;
providing an unobstructed image of the control panel to the processor;
blending the actual image with the unobstructed image with the processor to create a blended imager; and
providing the blended image to the processor.

20. The method of claim 19 wherein said step of providing an unobstructed image of the control panel includes the steps of obtaining an unobstructed image of the control panel.

21. The method of claim 20 wherein said step of providing an unobstructed view of the image includes the step of storing the unobstructed view after said step of obtaining an unobstructed view.

22. The method of claim 19 wherein said step of blending the actual image further includes the step of providing the unobstructed image as a background image and layering over the actual image while maintaining the visibility of the unobstructed image.
